(19) United States
(12) Patent Application Publication
(10) Pub. No.: US 2008/0232741 A1
(43) Pub. Date: Sep. 25, 2008

(54) CONNECTOR RECEPTACLE FOR USE WITH OPTICAL ELEMENTS

(75) Inventors: Barbara Grzegorzewska, Riverside, IL (US); Ilya Makhlin, Wheeling, IL (US); Thomas R. Marrapode, Naperville, IL (US); Javier Resendez, Streamwood, IL (US); Richard A. Nelson, Geneva, IL (US); Kent E. Regnier, Lombard, IL (US)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/689,577

(22) Filed: Mar. 22, 2007

(51) Int. Cl. G02B 6/38

(52) U.S. Cl. 385/55

(57) ABSTRACT

A connector receptacle comprises a housing having a forward mating end and a rear end, with an internal surface provided within the housing facing toward the rear end. The internal surface comprises at least a one alignment structure to engage and thereby maintain one or more optical elements in horizontal and vertical alignment. A clip having at least one retention mechanism engages complementary features on the housing to thereby retain the clip in fixed alignment with the housing. The clip also comprises at least one resilient member to bias the at least one optical element into mating engagement with the one or more alignment structures. Where the housing and clip are fabricated from electrically conductive materials, the clip may comprise one or more corresponding continuity pins to be received in continuity slots of the housing. Features of the clip to accommodate either surface mounting or through-hole mounting configurations are provided.

### FIELD OF THE INVENTION

The present invention relates generally to connector assemblies and, in particular, to a connector receptacle for use with one or more optical elements.

### BACKGROUND OF THE INVENTION

Connector assemblies for use with optical elements are well-known in the art. For example, U.S. Pat. Nos. 6,527,450; 6,609,833; 6,709,166; and 6,676,138 (collectively, “the Miyachi patents”, the teachings of which are incorporated herein by this reference) describe various aspects of a connector assembly having particular utility with regard to so-called Small Multi-media Interface (SMI) components. In particular, the Miyachi patents teach a connector assembly comprising a plug (or male) connector and a receptacle (or female) connector that may be brought into latching engagement with one another along a longitudinal, mating axis. While the connector assemblies illustrated and described in the Miyachi patents generally work well for their intended purpose, various aspects of the described connector assembly may be improved upon.

For example, as best illustrated in the '138 patent, the receptacle connector of the connector assembly comprises an outer housing and inner housing that slides into the outer housing along a vertical axis substantially perpendicular to the mating axis. The inner housing includes cavities for receiving optical elements in the vertical direction, thereby substantially enclosing the optical elements within the inner housing. Experience has shown that, on occasion, the optical elements may be mis-aligned along the vertical direction thereby decreasing performance or prohibiting proper performance all together. Furthermore, connector assemblies of the type illustrated in the Miyachi patents have heretofore been designed strictly for through-hole mounting on a printed circuit board (PCB). To this end, the receptacle connector taught in the '138 patent additionally comprises pins that allow the receptacle connector to be mounted on the underlying PCB using known, through-hole soldering techniques. While a through-hole mounting technique is acceptable for most applications, other mounting techniques, such as surface mounting, may provide certain advantages. Furthermore, it would be beneficial, particularly from the point of view of complexity of fabrication and assembly, if the number of parts used in fabricating the connector receptacle could be reduced.

Thus, it would be advantageous to provide a connector assembly that provides the additional benefits and overcomes the prior art limitations described above. In particular, a connector receptacle that provides improved alignment of optical elements, allows for other mounting configurations and reduced complexity of fabrication/assembly would represent an advancement of the art.

### SUMMARY OF THE INVENTION

The present invention provides a connector receptacle having improved alignment features, greater mounting capabilities and reduced fabrication/assembly complexity in comparison with prior art devices. In one embodiment of the present invention, the connector receptacle comprises a housing having top and side walls defining a cavity comprising a forward mating end and a rear end. An internal surface is provided within the cavity of the housing facing toward the rear end. The internal surface, in turn, comprises at least a one alignment structure for engaging one or more optical elements to thereby maintain the one or more optical elements in alignment along horizontal and vertical axes. The connector receptacle of this first embodiment further comprises a clip having at least one retention mechanism for engaging complementary features on the housing to thereby retain the clip in fixed alignment with the housing. The clip also comprises at least one resilient member to bias the at least one optical element into mating engagement with the one or more alignment structures. Because the one or more optical elements are received in the optical housing along a mating axis, as opposed to the vertical or horizontal axis, mating engagement between the alignment structures of the housing and the optical elements is better assured.

In another embodiment of the present invention, the housing described above is fabricated from an electrically conductive polymer and comprises one or more continuity slots. In this embodiment, the clip, fabricated from a conductive material, likewise comprises one or more corresponding continuity pins to be received in the continuity slots. Each continuity pin of the clip comprises at least one cutting member configured to penetrate a surface layer of the housing polymer. In this manner, the clip is able to establish electrical continuity between the housing and the clip thereby providing suitable electrical grounding of the entire connector receptacle. In a presently preferred embodiment, each of the at least one continuity pin comprises one or more electrical contact members having a lateral profile greater than the one or more cutting members to thereby assure electrical contact between the clip and the housing.

In a presently preferred embodiment, the clip described above comprises one or more retention tabs for use in a surface mount configuration. Alternatively, through-hole pins may be provided on the clip for through-hole mounting onto PCB or other suitable substrate. In yet another embodiment of the present invention, both the housing and clip are fabricated from a non-conductive and non-magnetic polymer. In this embodiment, the connector receptacle additionally comprises at least one retention tab configured to be retained in one or more retention slots formed in the housing, the one or more retention tabs being used for a surface mounting (or, alternatively, through-hole mounting) configuration. In this manner, the present invention provides an improved connector receptacle having more reliable performance and mounting flexibility and simplified fabrication and assembly.

### BRIEF DESCRIPTION OF THE DRAWINGS

The features of the present invention are set forth with particularity in the appended claims. The present invention itself, together with further features and attendant advantages, will become apparent from consideration of the following detailed description, taken in conjunction with the accompanying drawings. One or more embodiments of the invention are now described, by way of example only, with reference to the accompanying drawings in which:

FIG. 1 is a top, rear/side isometric view of a housing in accordance with the present invention;

FIG. 2 is a top, front/side isometric view of a housing in accordance with the present invention;

FIG. 3 is a front, perspective view of a clip in accordance with the present invention;

FIG. 4 is a top plan view of a clip in accordance with the present invention, including a magnified view of a continuity pin accordance with a presently preferred embodiment;

FIG. 5 is a top, side/front, exploded isometric view of a connector receptacle, comprising a housing and clip in accordance with the present invention, as well as optical elements and a printed circuit board in accordance with a presently preferred embodiment;

FIG. 6 is a top, side/rear isometric view of a connector receptacle mounted on a printed circuit board in accordance with the present invention;

FIG. 7 is a vertical cross-sectional view of the connector receptacle in accordance with the present invention;

FIG. 8 is a horizontal cross-sectional view of a connector receptacle in accordance with the present invention;

FIG. 9 is a top, rear/side isometric view of an alternative embodiment of a clip in accordance with the present invention;

FIG. 10 is a top, rear/side isometric view of an alternative embodiment of a housing and retention tabs in accordance with the present invention;

FIG. 11 is a top, side/front isometric view of the alternative housing of FIG. 10 in which the retention tabs have been positioned within retention slots of the housing in accordance with the present invention; and

FIG. 12 is a top, front/side isometric view of an alternative embodiment of a clip in accordance with the present invention.

### DETAILED DESCRIPTION OF THE PRESENT EMBODIMENTS

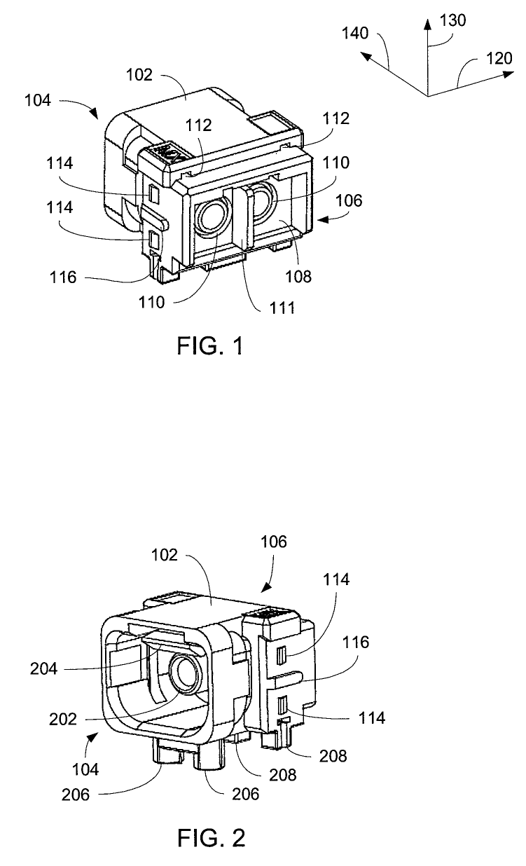

Referring now to FIGS. 1 and 2, a preferred embodiment of a housing 102 in accordance with the present invention is further illustrated. In particular, the housing 102 comprises top and side walls having a forward mating end 104 and a rear end 106 defining a longitudinal passage or cavity therein. As shown, a longitudinal axis of the housing 102 is oriented along a mating axis 140. An internal wall provided within the cavity (substantially perpendicular to the mating axis 140 and co-planar with horizontal and vertical axes 120, 130) bisects the cavity and includes an internal surface 108. The internal surface 108 comprises one or more alignment structures 110, 111, configured as described in further detail below, to receive complementary alignment structures or surfaces of one or more optical elements to be enclosed within the connector receptacle. In a presently preferred embodiment, the housing 102 includes alignment structures 110 to accommodate two optical elements. In particular, the optical elements may comprise fiber optic transceivers (FOTS), such as those manufactured by Firecomms. In the embodiment illustrated in FIG. 1, an additional alignment structure 111 comprises a vertical separator wall to provide proper spacing between the optical elements. Although the instant disclosure makes numerous references to use of the inventive connector receptacle with optical elements, it should be understood that the present invention need not be so limited and can be used with other types of connector assemblies, such as electric connector assemblies. Indeed, many different connector assemblies include mating receptacle and plug connectors or female and male connectors and may benefit from various aspects of the present invention.

In accordance with another embodiment of the present invention, one or more continuity slots 112 are provided in the housing 102, preferably facing the rear end 106 of the housing 102. For example, in the embodiment shown, two continuity slots 112 are provided in a rearward facing configuration. As described in further detail below, the continuity slots 112 allow a continuity pin to establish electrical continuity between the housing and the clip.

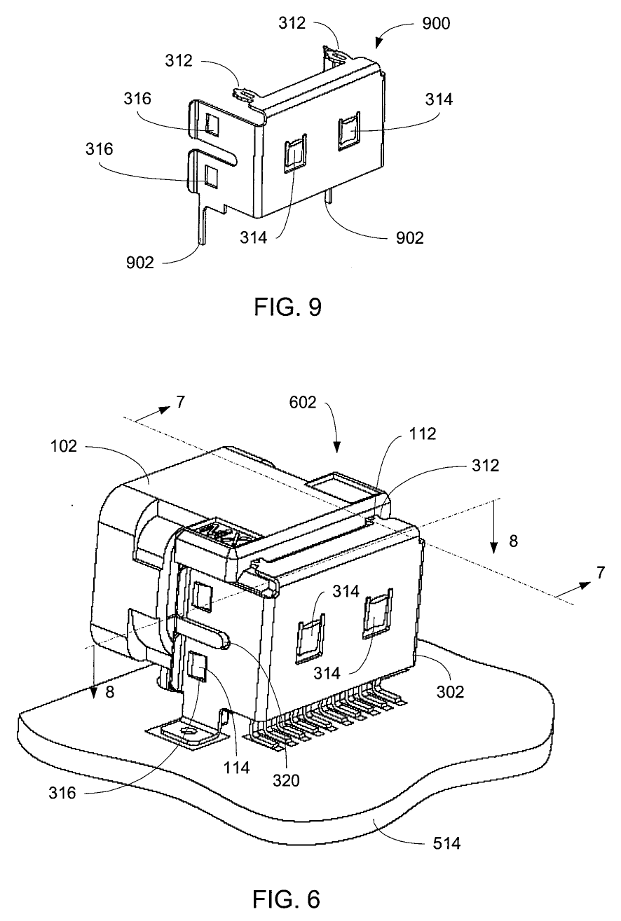

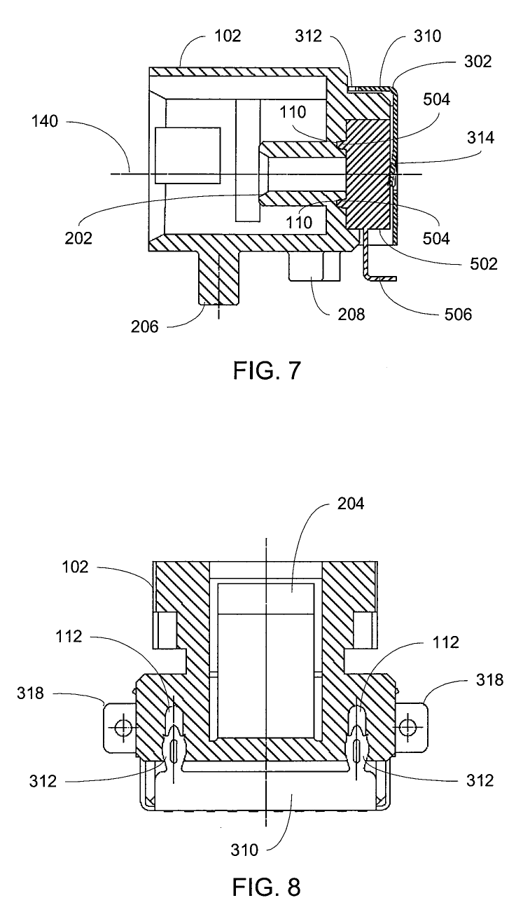

One or more complementary mating (retention) features or retention bosses 114 are preferably disposed on sidewalls of the housing 102. Similarly, at least one alignment boss 116 is also preferably provided. As best illustrated in FIG. 6, the retention boss(es) 114 and alignment boss(es) 116 allow a corresponding clip to be maintained in substantially fixed alignment with the housing 102. As illustrated in FIG. 2, the housing 102 comprises additional structures for mating with a complementary mating device (not shown). One or more forwardly projecting cylindrical portions 202 are mounted on a side of the internal wall opposite the internal surface 108, each cylindrical portion 202 forming a passage through the internal wall (see FIG. 7). As taught by the Miyachi patents, the forwardly projecting cylindrical portions 202 engage complementary mating portions of a plug connector. Additionally, a latch 204, as known in the art, is provided to provide latching engagement with the complementary mating device, i.e., plug connector, thereby insuring a mechanically stable connection. As known in the art, one or more location pegs 206 may also be provided, as well as one or more positive stops 208 to ensure proper alignment of the housing 102 when mounted on a suitable printed circuit board or other substrate.

In a presently preferred embodiment, the housing 102 is fabricated from or more electrically conductive polymers, such as Stat-Kon OC-1003 manufactured by General Electric. As known in the art, such conductive polymers typically comprise electrically conductive and/or EMI (electromagnetic interference)-resistant fillers. Using an electrically conductive polymer, the housing 102 may offer EMI protection and electrical grounding. Furthermore, where the housing 102 is to be used in a surface mount configuration, the constituent polymer used to form the housing is preferably provided with relatively high temperature resistance, i.e., suitable for temperatures of a least 260° C. In an alternative embodiment, the housing 102 may be made from the non-conductive, non-EMI protective polymer, such as Thermocomp OF-1006, also manufactured by General Electric. Use of such non-conductive polymers is particularly beneficial in situations in which a substantially non-magnetic configuration is preferred, i.e., for use in a magnetic resonance imaging (MRI) system where magnetically-susceptible materials would lead to decreased performance.

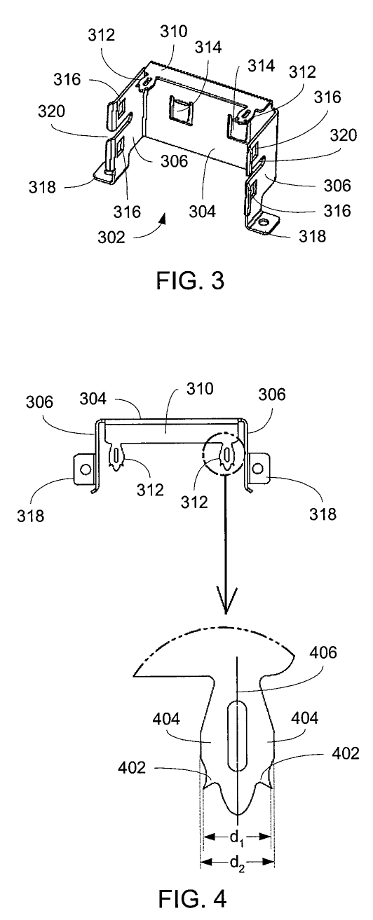

Referring now to FIGS. 3 and 4, a clip 302 in accordance with one embodiment of the present invention is further illustrated. In particular, the clip 302 comprises a back wall 304 and two sidewalls 306 substantially parallel to each other and perpendicular to the back wall 304. Likewise, a top wall 310 is provided substantially perpendicular to both the back wall 304 and the sidewalls 306. A distance between the sidewalls 306 is selected as to provide snug but slidable engagement with external surfaces of the housing 102 sidewalls when the clip 302 is mounted on the housing 102. In one aspect of the present invention, one or more continuity pins 312 are presented as extensions of the top wall 310. In a currently preferred embodiment, the top wall includes two continuity pins as shown. Preferably, the continuity pins 312 are substantially co-planar with the top wall 310. As described in greater detail below, the continuity pins 312 establish electrical continuity between the clip 302 and the housing 102 to provide suitable EMI resistance and/or electrical grounding for the entire connector receptacle. In yet another aspect of the present invention, the back wall 304 comprises one or more (preferably two) resilient members 314 as shown. The resilient members 314 are configured to slightly project inward from the back wall 304 (i.e., in the same direction as the continuity pins 312) such that when clip 302 is mounted on the housing 102, the resilient members 314 operate to urge the one or more optical elements into engagement with the corresponding alignment structures formed in the housing 102. Preferably, the resilient members 314 are formed integral to the back wall 304. However, in other (albeit less preferred) embodiments, the resilient members 314 could be provided as physically separate components that are mounted on or otherwise in contact with the back wall 304.

In a presently preferred embodiment, particularly where continuity pins 312 are provided, the clip 302 is fabricated from a conductive material such as metal. For example, in a presently preferred embodiment, the clip 302 is fabricated from a tin-plated beryllium-copper alloy. Additionally, the material used to fabricate the clip 302 preferably provides a degree of flexibility and low permanent deformation such that the clip 302 may placed and retained in interlocking engagement with the housing 102. For example, as shown, the clip 302 may also comprise one or more retention mechanisms or recesses 316 formed therein. The recesses 316 are configured to latchingly engage the retention bosses 114 of the housing 102. In this manner, the clip 302 is maintained in substantial alignment with the housing 102 along the mating axis 140. In order to maintain the clip 302 in proper vertical alignment with the housing 102, one or more alignment slots 320 may be provided in the sidewalls 306 to slidingly engage corresponding alignment bosses 116 formed in the sidewalls of the housing 102. Additionally, where the clip 312 is intended for use in a surface mount configuration (as illustrated in FIGS. 3 and 4), one or more retention tabs 318, substantially perpendicular to the sidewalls 306, are provided thereby allowing the clip 302 to be attached (typically, soldered) to an appropriate printed circuit board or other substrate. Where the clip 302 and housing 102 are electrically conductive, the retention tabs 318 are typically used to provide electrical communication with suitable electrical grounding structures and/or circuitry.

Referring now to FIG. 4, a top, magnified view of a preferred continuity pin 312 is provided. In particular, the continuity pin 312 is shown to have one or more cutting members 402 disposed near the front of the continuity pin 312. As known in the art, the housing 102, when fabricated from an electrically conductive polymer, will form a non-conductive skin or surface layer encompasses the underlying and otherwise electrically conductive material. In order to establish electrical continuity between the housing 102 and the clip 302, the cutting members 402 are provided and configured having dimensions suitable to penetrate all the way through the electrically non-conductive surface layer of the polymer, thereby exposing the electrically conductive material beneath. In a presently preferred embodiment, additional contact members 404 are provided immediately rearward of the cutting members 402 and are provided to establish electrical contact with the housing after the cutting members 402 have exposed the underlying conductive material. In a currently preferred embodiment, the contact members 404 are substantially co-planar with the cutting members 403, although this is not a requirement. As shown, each continuity pin preferably comprises a pair of cutting members 402 and a pair of contact members 404 distributed in a mirrored configuration about a center line 406 of the continuity pin 312. Also in a presently preferred embodiment, a lateral profile of the cutting members 402 (illustrated as d₁) is preferably less than a lateral profile of the contact members 404 (illustrated as d₂). In this manner, the contact members 404 are better assured of making good electrical contact with the underlying electrically conductive polymer of the housing 102 after penetration thereof by the cutting members 402.

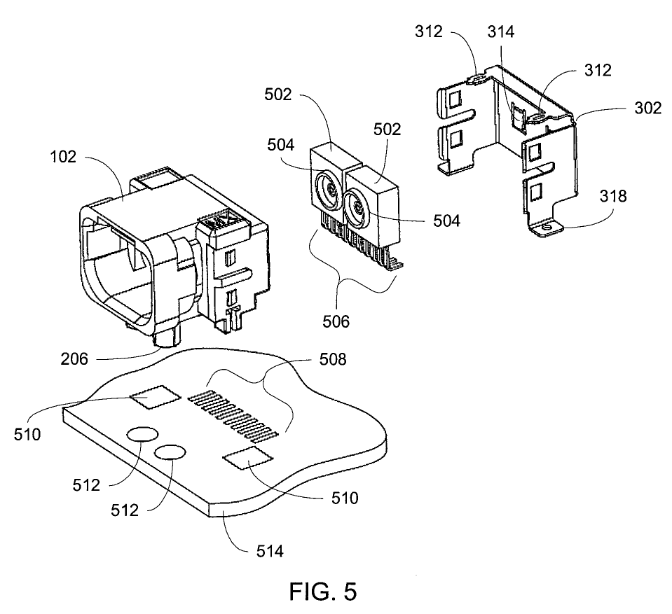

Referring now to FIG. 5, alignment of a housing 102 and clip 302 in accordance with the present invention is further illustrated in conjunction one or more optical elements 502 and a printed circuit board 514. As shown, the optical elements 502 each comprise alignment features 504 that are complimentary to the alignment features 110 formed in the internal surface 108 of the housing 102. In a presently preferred embodiment, the alignment features 110, 504 comprise a circular, annular structure that substantially maintains the optical elements 502 in alignment along the horizontal axis 120 and vertical axis 130. Those of ordinary skill in the art will appreciate that other complementary structure shapes may be employed as a matter of design choice when implementing the alignment features 110, 504. Additionally, the vertical separator wall 111 (as well as the side and top walls of the housing 102) are preferably configured to prevent rotational misalignment of the optical elements 502, i.e. so that the top and side surfaces of the optical elements 502 snugly fit within a space defined by the vertical separator wall 111, top and side walls of the housing 102.

The embodiment depicted in FIG. 5 is particularly directed to a surface mount configuration. As such, each of the optical elements 502 comprises one or more surface mount bonding pins 506 as known in the art. As further shown, the printed circuit board 514 comprises corresponding surface mount bonding pads 508 as known in the art. Likewise, the printed circuit board 514 comprises retention bonding pads 510 for receiving the retention tabs 318 of the clip 302 when the clip 302 is soldered to the printed circuit board 514. In a presently preferred embodiment, the retention bonding pads 510 are electrically coupled to suitable grounding structures and/or circuitry. Additionally, in the embodiment shown, the printed circuit board 514 also comprises one or more alignment holes 512 for receiving corresponding ones of the location pegs 206 to properly maintain the housing 102 in alignment relative to the printed circuit board 514. As described in greater detail below, the present invention may also be adapted for other mounting configurations, particularly a through-hole mounting configuration.

Referring now to FIGS. 6-8, various illustrations of the fully assembled connector receptacle 602 are provided. It should be noted that the optical elements 502, while encompassed by the connector receptacle 602, do not form a part thereof. As shown in FIG. 6, the clip 302 is secured to the housing 102 via interlocking engagement of the retention recesses 316 with the corresponding retention bosses 114. Similarly, FIG. 6 illustrates the engagement of the alignment slots 320 with the corresponding alignment bosses 116. It is worth noting that the entire connector receptacle 602 is fabricated from only two parts, namely the housing 102 and clip 302, whereas prior art connector receptacles typically comprise a greater number of parts.

Referring now to FIG. 7, illustrating a cross-section taken along section line 7-7 illustrated in FIG. 6, interaction between the housing 102, clip 302 and optical element 502 is further shown. In particular, it is noted how the complimentary alignment features 110, 504 of the housing 102 and optical element 502 engage each other. Additionally, it is noted that the resilient element 314, being in contact with a rear surface of the optical element 502, biases the optical element 502 into engagement with the housing 102. Further interaction between the clip 302 and housing 102 is illustrated in FIG. 8 (illustrating a cross-section taken along cross-section line 8-8 of FIG. 6). As shown, the continuity pins 312 are inserted into the corresponding continuity slots 112. Note that the dimensions of the continuity pin 312, particularly the lateral dimensions of both the cutting members and the electrical contact members, are greater than a width of the corresponding continuity slot 112. In this manner, the electrical continuity between the clip 302 and the housing 102 is better assured.

An alternative embodiment of a clip 900 in accordance with the present invention is further illustrated in FIG. 9. In particular, the alternative clip 900 comprises one or more through-hole pins 902 in place of the retention tabs 318 previously described above. The alternative clip arrangement 900 is preferably used for those configurations in which a through-hole construction is used in the underlying printed circuit boards, as known to those having ordinary skill in the art. Note that other features of the clip 900, such as the continuity pins 312, resilient members 314 and retention recesses 316, are substantially similar to the earlier-described embodiment.

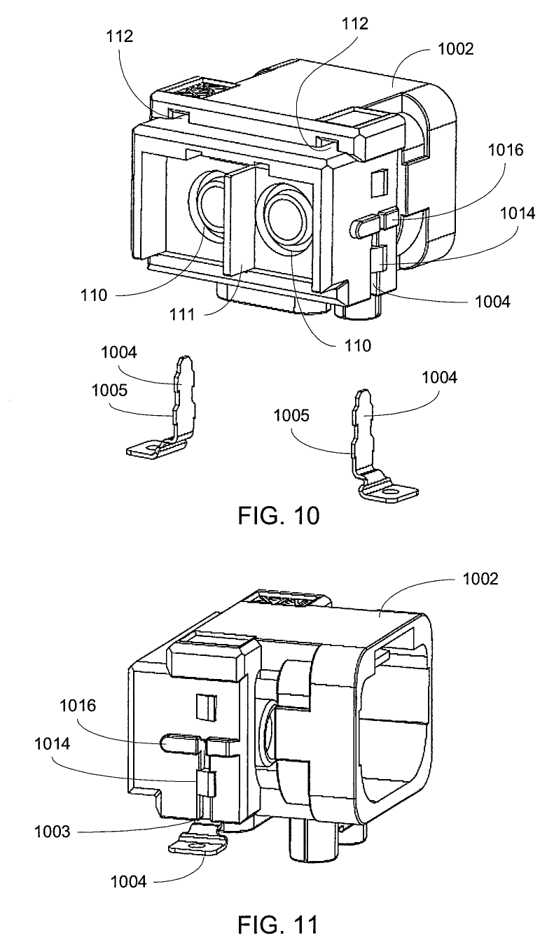

Referring now to FIGS. 10 and 11, an alternative embodiment of a housing 1002 in accordance with the present invention is further illustrated. In particular, the housing 1002 may be used in those situations in which it is desirable to minimize the amount of magnetic material used in construction of the connector receptacle. In this instance, the housing 1002 is fabricated from non-magnetic material as described above. However, in order to preserve the ability to mount the housing 102 in a surface mount configuration, one or more retention slots 1003 are provided, preferably within sidewalls of the housing 1002. In order to secure the housing 1002 to a printed circuit board in a surface mount configuration, one or more retention tabs 1004, corresponding the retention slots 1003, are also provided. In a presently preferred embodiment, the retention tabs 1004 are fabricated from a nonmagnetic material, such as copper, although those of ordinary skill in the art will appreciated that other non-magnetic materials (or magnetic materials, if desired) may be equally employed. In order to securely retain the retention tabs 1004 within the retention slots 1003, each retention tab 1004 is preferably provided with one or more teeth 1005 configured to provide a snug press fit of the retention tab 1004 within the retention slot 1003. In an alternative embodiment, rather than using separate, press-fit retention tabs 1004 as shown, separate, press-fit retention through-hole pins (fabricated from magnetic or non-magnetic materials as a matter of design choice) may be employed in the embodiment of FIGS. 10 and 11 where a through-hole mounting configuration is desired.

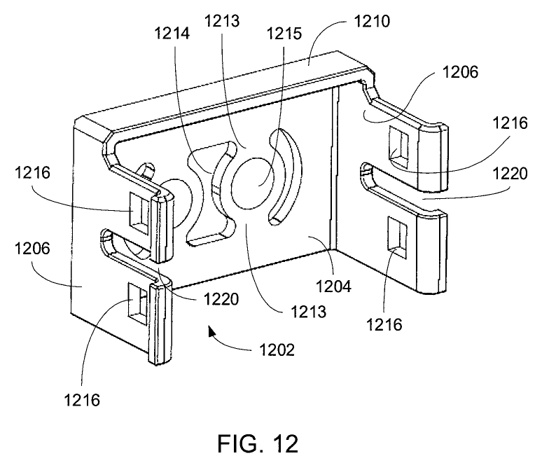

Referring now to FIG. 12, yet another alterative embodiment of a clip 1202 in accordance with the present invention is shown. In particular, the clip 1202 illustrated in FIG. 12 is preferably fabricating from a non-magnetic material as described above. Although, in a presently preferred embodiment, the clip 1202 is fabricated from the same non-magnetic polymer as the housing 1002 described above, this is not a requirement and the clip 1202 could be fabricated from a different non-magnetic material as a matter of design choice. As shown, the clip 1202 comprises a back wall 1204 and a pair of sidewalls 1206 substantially perpendicular thereto. Likewise, a top wall 1210, perpendicular to both the backwall 1204 and sidewalls 1206, may also be provided. Note that, in this configuration, the clip 1202 preferably does not include continuity pins. However, as in the earlier described embodiments, the clip 1202 may comprise one or more retention mechanisms or recesses 1216 as well as one or more alignment slots 1220. Additionally, the clip 1202 comprises one or more resilient members 1214 that are substantially integral to the clip 1202. In particular, each resilient member, as shown, comprises one or more protrusions or bumps 1215 coupled via flexible web members 1213 to the remainder of the back wall 1204. When the clip 1202 is mounted on a corresponding housing (as described above), the protrusion 1215 engages a rear surface of a corresponding optical element thereby urging the corresponding optical element into engagement with the housing by operation of the flexing provided by the web members 1213. Those of ordinary skill in the art will appreciate that other configurations of the resilient members 1214, which may or may not be integral to the clip 1202, may be equally employed as a matter of design choice.

The present invention provides a connector receptacle having improved alignment features, greater mounting capabilities and reduced fabrication/assembly complexity in comparison with prior art devices. This is accomplished with a simplified housing and clip design in which the housing includes an internal surface having alignment features for aligning one or more optical elements brought into contact with the housing. The clip includes resilient members that further urge the optical elements into engagement with the alignment features of the housing. Further still, particularly where the housing and clip are fabricated from electrically conductive materials, one or more continuity pins may be provided in the clip for engagement with corresponding continuity slots in the housing. Cutting members in the continuity pins penetrate any non-conductive surface layer of the housing, thereby better assuring electrical continuity between the housing and the clip.

While the particular preferred embodiments of the present invention have been shown and described, it will be obvious to those skilled in the art that changes and modifications may be made without departing from the teachings of the invention. It is therefore contemplated that the present invention cover any and all modifications, variations or equivalents that fall within the spirit and scope of the basic underlying principles disclosed above and claimed herein.

What is claimed is:

1. A connector receptacle for mating with a complementary mating device along a mating axis, comprising:
a housing having a forward mating end for mating with the complementary mating device, a rear end and an internal surface facing toward the rear end, the internal surface comprising at least one alignment structure for substantially maintaining at least one optical element in alignment along horizontal and vertical axes substantially perpendicular to the mating axis; and
a clip comprising at least one retention mechanism for engaging complementary features on the housing to substantially maintain the clip relative to the housing along the mating axis and comprising at least one resilient member to bias the at least one optical element into mating engagement with the at least one alignment structure.

2. The connector receptacle of claim 1, wherein the at least one alignment structure comprises a recess formed in the internal surface.

3. The connector receptacle of claim 2, wherein the recess is substantially circular.

4. The connector receptacle of claim 1, wherein the housing and the clip are fabricated from at least one polymer.

5. The connector receptacle of claim 4, the housing comprising at least one retention slot, the connector receptacle further comprising:
at least one retention tab configured to be received in a corresponding one of the at least one retention slot.

6. The connector receptacle of claim 1, wherein the housing is fabricated from an electrically conductive polymer and the clip is fabricated from an electrically conductive material.

7. The connector receptacle of claim 6, the housing comprising at least one continuity slot for receiving at least one continuity pin on the clip, wherein each of the at least one continuity pin comprises at least one cutting member configured to penetrate a surface layer of the housing.

8. The connector receptacle of claim 7, wherein each of the at least one continuity pin comprises at least one electrical contact member configured to establish electrical contact with the housing.

9. The connector receptacle of claim 6, the clip comprising at least one retention tab.

10. The connector receptacle of claim 6, the clip comprising at least one retention through-hole pin.

11. The connector receptacle of claim 1, wherein the at least one resilient member is formed integral to the clip.

12. A connector receptacle for mating with a complementary mating device along a mating axis, comprising:
a housing, fabricated from a conductive polymer, having a forward mating end for mating with the complementary mating device and having at least one continuity slot; and
a clip, fabricated from a conductive material, comprising at least one continuity pin to be received in corresponding ones of the at least one continuity slot, wherein each of the at least one continuity pin comprises at least one cutting member configured to penetrate a surface layer of the housing.

13. The connector receptacle of claim 12, wherein each of the at least one continuity pin comprises at least one electrical contact member configured to establish electrical contact with the housing.

14. The connector receptacle of claim 13, wherein each of the at least one electrical contact member is substantially co-planar with a corresponding one of the at least one cutting member.

15. The connector receptacle of claim 14, wherein a lateral profile of the at least one electrical contact member relative to a center line of a corresponding continuity pin of the at least one continuity pin is greater than a lateral profile of the at least one cutting member relative to the center line of the corresponding continuity pin.

16. The connector receptacle of claim 12, wherein a width of the at least one continuity slot is less than a lateral profile of the at least one cutting member relative to a center line of a corresponding continuity pin of the at least one continuity pin.

17. The connector receptacle of claim 12, the housing further comprising a rear end and an internal surface facing the rear end, the internal surface comprising at least one alignment structure for substantially maintaining at least one optical element in alignment along horizontal and vertical axes substantially perpendicular to the mating axis, and the clip further comprising at least one resilient member to bias the at least one optical element into mating engagement with the at least one alignment structure.

18. The connector receptacle of claim 17, wherein the at least one resilient member is formed integral to the clip.

19. The connector receptacle of claim 12, the clip comprising at least one retention tab.

20. The connector receptacle of claim 12, the clip comprising at least one retention through-hole pin.

21. A connector receptacle for mating with a complementary mating device along a mating axis, comprising:
a housing, fabricated from an electrically conductive polymer, having a forward mating end for mating with the complementary mating device, a rear end and an internal surface facing toward the rear end, the internal surface comprising at least two recesses for receiving mating structures of at least two optical elements, thereby substantially maintaining the at least two optical elements in alignment along horizontal and vertical axes substantially perpendicular to the mating axis, the rear end comprising at least two continuity slots facing the rear end; and
a clip, fabricated from an electrically conductive material, comprising retention recesses for engaging corresponding retention bosses on the housing to substantially maintain the clip relative to the housing along the mating axis, and comprising at least two integral resilient members to bias the at least two optical elements into mating engagement with corresponding ones of the at least two recesses, and further comprising at least one continuity pins configured to be received in corresponding ones of the at least two continuity slots, wherein each of the at least two continuity pins comprises cutting members configured to penetrate a surface layer of the housing.

22. A connector receptacle for mating with a complementary mating device along a mating axis, comprising:
a housing, fabricated from a polymer, having a forward mating end for mating with the complementary mating device, a rear end and an internal surface facing toward the rear end, the internal surface comprising at least two recesses for receiving mating structures of at least two optical elements, thereby substantially maintaining the at least two optical elements in alignment along horizontal and vertical axes substantially perpendicular to the mating axis, and having at least two retention slots;
a clip, fabricated from the polymer, comprising retention recesses for engaging corresponding retention bosses on the housing to substantially maintain the clip relative to the housing along the mating axis, and comprising at least two integral resilient members to bias the at least two optical elements into mating engagement with corresponding ones of the at least two recesses; and
at least two retention tabs configured to be received in corresponding ones of the at least two retention slots.
